(19) United States
(12) Patent Application Publication
(10) Pub. No.: US 2004/0158627 A1
(43) Pub. Date: Aug. 12, 2004

(54) Computer condition detection system

(76) Inventor: Barry W. Thornton, Austin, TX (US)

Correspondence Address: Jeffrey C. Hood, Meyertons, Hood, Kivlin,, Kowert & Goetzel PC, P.O. Box 398, Austin, TX, 78767, US

(21) Appl. No.: 10/364,584

(22) Filed: Feb. 11, 2003

(51) Int. Cl. G06F 15/173; G06F 15/16

(52) U.S. Cl. 709/224; 709/202

(57) ABSTRACT

A computer condition detection system for detecting conditions of computer components to predict a failure. Conditions on computer components may be detected by a health computer coupled to a main computer (e.g., a computer blade). The health computer may be coupled to sensors on various computer components for detecting conditions such as temperature, airflow velocity, voltage, and current. The health computer may be coupled to an independent health network and may be powered by a separate power supply than the main computer power supply to detect problems even if the main computer fails. The main computer may also be coupled to the sensors to detect conditions on the main computer's components. If a condition is detected that meets a predetermined criterion, corrective or preparative actions may be taken. For example, data on the main computer may be backed up in anticipation of a main computer failure.

### BACKGROUND OF THE INVENTION

1. Field of the Invention

The present invention relates generally to computer systems and specifically to a system for monitoring and detecting conditions on a computer system.

2. Description of the Related Art

Many businesses and homeowners use computers in their daily operations. Many computers are also coupled together over networks that allow computers to share information with each other and with a central server. As computers and computer networks become faster and more complex, more people are depending on them to carry out critical operations and store critical data. However, as computers increase in complexity, the number of potential failure points in computers may also rise. Computer components may fail for many reasons including overheating, short-circuiting, and/or burning-out due to power surges. Computer components may also fail because of manufacturing defects or accidents caused by users, such as, for example, dropping the computer, spilling fluids, etc. Additionally, a failure in one component may lead to failures in other components. For example, if a defective fan circulating air inside the computer fails, other computer components such as a power supply and/or a processor may also fail as the temperature increases.

Computers may not have a way to detect a component that has failed or is failing, and thus, administrators of computers may be forced to respond to a computer failure after it occurs. Because administrators may not be able to respond to a computer until after a failure occurs, time and/or data may be lost. For example, a failure may cause data stored in random access memory (RAM) to be lost, and/or data stored on a hard drive to become corrupted.

Therefore, improved systems and methods for monitoring and detecting conditions on computers are desired.

### SUMMARY OF THE INVENTION

Various embodiments of a system and method for monitoring conditions on a computer system are presented. One embodiment of a computer condition detection system may include one or more sensors coupled to a first computer to measure one or more attributes of the first computer. In one embodiment, the one or more sensors coupled to the first computer may measure attributes such as, but not limited to, temperature, airflow velocity, airflow volume, voltage, current, and accelerations of the first computer. In one embodiment, the sensors may communicate the measured attributes to a health computer powered by a power supply not used to power the first computer. In another embodiment, the health computer may monitor the measured attributes in order to detect conditions on the first computer. In yet another embodiment, the first computer may monitor the measured attributes to detect conditions.

A condition may be detected using the measured attributes, e.g., if the measured attribute meets one or more predetermined criterion. Other ways that measured attributes may indicate a condition may also be within the scope of the invention. For example, a performance metric may be calculated from a plurality of measured attributes, or from a history of accumulated attributes, and compared to the predetermined criteria. In another embodiment, the plurality of measured attributes or history of accumulated attributes may be analyzed according to a pattern defined by the predetermined criteria (e.g., a pattern of concurrent attributes, a history of decreasing air flow or increasing temperature, etc.). Other methods of analyzing the measured attributes are also contemplated.

If a condition is detected, one or more actions may be performed. For example, the condition may be reported over a health network or may be reported to the first computer directly. In one embodiment, a second computer on the health network or the first computer itself may try to correct the condition and/or attempt to prepare for a failure of the first computer. Other actions in response to detected conditions are also contemplated.

Thus, various embodiments of a computer condition detection system may facilitate early detection of possible problems related to computer system operations, and may also provide means for correcting and/or ameliorating the problems to minimize downtime and/or damage to the computer and/or related systems.

### BRIEF DESCRIPTION OF THE DRAWINGS

A better understanding of the present invention can be obtained when the following detailed description of the preferred embodiment is considered in conjunction with the following drawings, in which:

FIG. 1 illustrates computer systems including peripheral devices coupled to computer blades in a cage, according to one embodiment;

FIG. 2 illustrates a computer blade out of the cage, according to one embodiment;

FIG. 3 illustrates a computer blade having a power supply, hard drive, and motherboard, according to one embodiment;

FIG. 4A illustrates a computer blade coupled to a health computer, according to one embodiment;

FIG. 4B illustrates a computer blade with an incorporated health computer, according to one embodiment;

FIG. 5 illustrates a computer blade with an internal sensor interface, according to one embodiment; and

FIG. 6 flowcharts a method for detecting and reporting conditions meeting a predetermined criterion, according to one embodiment.

While the invention is susceptible to various modifications and alternative forms, specific embodiments thereof are shown by way of example in the drawings and are herein described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION OF THE EMBODIMENTS

Incorporation by Reference

U.S. Provisional Patent 60/144,809 titled “A Technique To Extend The Operating Distance Of A Universal Serial Bus” is hereby incorporated by reference in its entirety as though fully and completely set forth herein.

U.S. Pat. No. 6,119,146 titled “Computer Network Having Multiple Remotely Located Human Interfaces Sharing A Common Computing System”, which was filed May 4, 1998, whose inventors are Barry Thornton, Andrew Heller, Daniel Barrett, and Charles Ely, is hereby incorporated by reference in its entirety as though fully and completely set forth herein.

U.S. Pat. No. 6,038,616 titled “Computer System With Remotely Located Interface Where Signals Are Encoded At The Computer System, Transferred Through A 4-Wire Cable, And Decoded At The Interface”, which was filed May 4, 1998, whose inventors are Barry Thornton, Andrew Heller, Daniel Barrett, and Charles Ely, is hereby incorporated by reference in its entirety as though fully and completely set forth herein.

U.S. Pat. No. 6,012,101 titled “Computer Network Having Commonly Located Computing Systems”, which was filed May 4, 1998, whose inventors are Andrew Heller, Barry Thornton, Daniel Barrett, and Charles Ely, is hereby incorporated by reference in its entirety as though fully and completely set forth herein.

U.S. patent application Ser. No. 09/179,809 titled “A Technique To Transfer Multiple Information Streams Over A Wire Or Wireless Medium” is hereby incorporated by reference in its entirety as though fully and completely set forth herein.

U.S. patent application Ser. No. 09/619,989 titled “System And Method For Providing A Remote Universal Serial Bus”, which was filed Jul. 20, 2000, whose inventors are Dan Barrett, Mike Barron, and Andrew Heller, is hereby incorporated by reference in its entirety as though fully and completely set forth herein.

U.S. patent application Ser. No. 09/680,760 titled “System And Method For Combining Computer Video And Remote Universal Serial Bus In An Extended Cable”, which was filed Oct. 6, 2000, whose inventor is Barry Thornton, is hereby incorporated by reference in its entirety as though fully and completely set forth herein.

U.S. patent applicaton Ser. No. 09/728,667 titled “Computer On A Card With A Remote Human Interface”, which was filed Dec. 12, 2000, whose inventors are Andrew Heller and Barry Thornton, is hereby incorporated by reference in its entirety as though fully and completely set forth herein.

U.S. Pat. No. 5,530,960 titled “Disk drive controller accepting first commands for accessing composite drives and second commands for individual diagnostic drive control wherein commands are transparent to each other”, which was filed on Jun. 25, 1996, whose inventors are Terry J. Parks, Kenneth L Jeffries, and Craig S. Jones, is hereby incorporated by reference in its entirety as though fully and completely set forth herein.

U.S. Pat. No. 5,483,641 titled “System for scheduling readahead operations if new request is within a proximity of N last read requests wherein N is dependent on independent activities”, which was filed on Jan. 9, 1996, whose inventors are Terry J. Parks, Kenneth L Jeffries, and Craig S. Jones, is hereby incorporated by reference in its entirety as though fully and completely set forth herein.

U.S. patent applicaton Ser. No. 09/892,324 titled “Computer System Having a Remotely Located Human Interface Using Computer I/O Bus Extension”, which was filed Jun. 25, 2001, whose inventors are Ray DuPont, Mike Tullis, and Barry Thornton, is hereby incorporated by reference in its entirety as though fully and completely set forth herein.

U.S. patent applicaton Ser. No. 09/892,331 titled “System Comprising Multiple Co-Located Computer Systems Each Having a Remotely Located Human Interface Using Computer I/O Bus Extension”, which was filed Jun. 25, 2001, whose inventors are Ray DuPont, Mike Tullis, and Barry Thornton, is hereby incorporated by reference in its entirety as though fully and completely set forth herein.

U.S. Provisional Application Serial No. 60/304,066 titled “Distributed Computing Infrastructure” filed on Sep. 16, 2002, whose inventors are Amir Husain, Todd Enright, and Barry Thornton, is hereby incorporated by reference in its entirety as though fully and completely set forth herein.

U.S. patent application Ser. No. 10/301,536 titled “Data Fail-Over for a Multi-Computer System” filed on Nov. 21, 2002, whose inventors are Syed Mohammad Amir Husain, Todd John Enright, and Barry W. Thornton, is hereby incorporated by reference in its entirety as though fully and completely set forth herein.

U.S. patent application Ser. No. 10/301,518 titled “Distributed Resource Manager” filed on Nov. 21, 2002, whose inventors are Syed Mohammad Amir Husain, Todd John Enright, and Barry W. Thornton, is hereby incorporated by reference in its entirety as though fully and completely set forth herein.

U.S. patent application Ser. No. 10/301,563 titled “System and Method for Providing Virtual Network Attached Storage Using Excess Distributed Storage Capacity” filed on Nov. 21, 2002, whose inventors are Syed Mohammad Amir Husain, Todd John Enright, and Barry W. Thornton, is hereby incorporated by reference in its entirety as though fully and completely set forth herein.

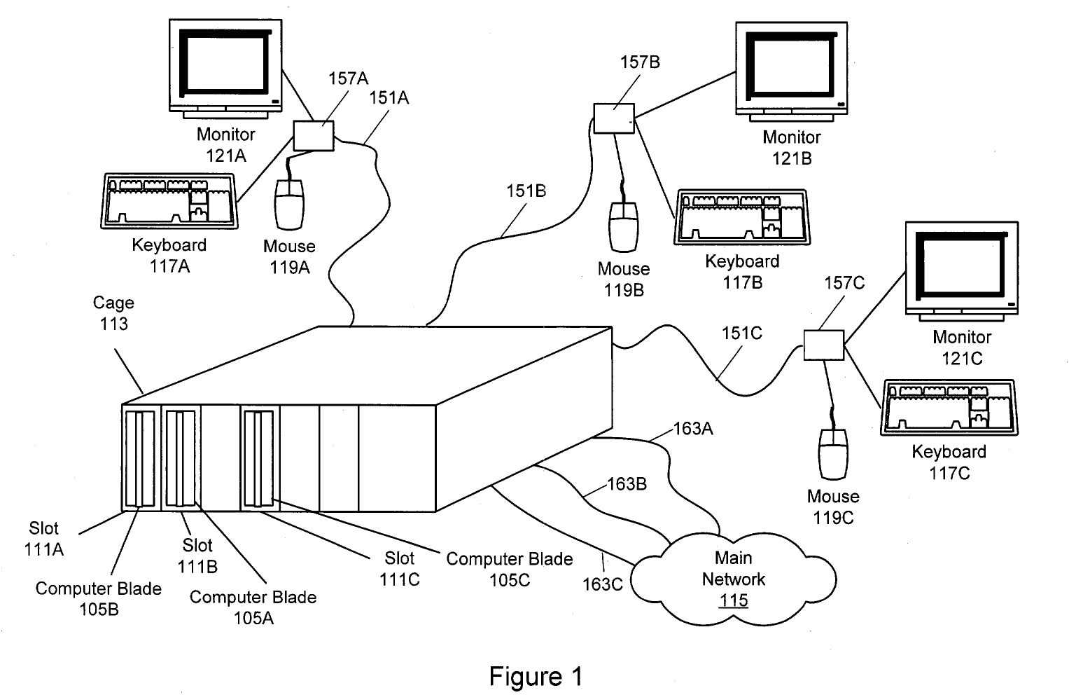

FIGS. 1-3—Elements of Computer Systems Used in Various Embodiments

FIGS. 1-3 illustrate computer system components that may be used in various embodiments of the invention. As FIG. 1 indicates, in a preferred embodiment, each computer system may include at least one peripheral device, e.g., comprised in a human interface, and a computer blade. The computer blade may include various components necessary for computer operations, such as, but not limited to, a processor and a storage medium. Other types of computer systems and components may also be within the scope of the invention, such as, for example, a plurality of networked desktop computers or workstations. For further information regarding the use of multiple computer blades in a system, please see U.S. patent applicaton Ser. No. 09/728,667 titled “Computer On A Card With A Remote Human Interface”, which was filed Dec. 12, 2000, whose inventors are Andrew Heller and Barry Thornton, which was incorporated by reference above.

As will be described in detail below, various embodiments of the present invention may be implemented using the systems of FIGS. 1-3, where, for example, sensors attached to various components of a computer blade may be monitored to detect and/or predict problems with the computer blade.

FIG. 1—Computer Blades and Respective Peripheral Devices

Referring to FIG. 1, an embodiment of computer systems including peripheral devices coupled to computer blades in a cage is shown. While one embodiment may include computer blades, it is noted that other computer types and forms may also be within the scope of the invention. In other words, the embodiment shown in FIG. 1 is intended to be exemplary only, and is not intended to limit the types or number of computer systems used.

As FIG. 1 shows, connecting cables 151A, 151B, and 151C may connect computer blades 105A, 105B, and 105C to respective peripheral device groups through respective device ports or hubs, 157A, 157B, and 157C. In one embodiment, each device port 157 may comprise an extender device that may enable transmission of user interface signals (i.e., peripheral device signals) over distances generally not allowed by standard protocols such as Universal Serial Bus (USB). For further information regarding extended communications between a computer and a remote human interface, please see U.S. patent applicaton Ser. No. 09/892,324 titled “Computer System Having a Remotely Located Human Interface Using Computer I/O Bus Extension”, and U.S. patent application Ser. No. 09/892,331 titled “System Comprising Multiple Co-Located Computer Systems Each Having a Remotely Located Human Interface Using Computer I/O Bus Extension”, both of which were incorporated by reference above.

In one embodiment, the peripheral device groups, such as the peripheral device group coupled to connecting cable 151, may include a keyboard 117, a pointing device, e.g., a mouse 119, a display device, e.g., a computer monitor 121, and/or other peripheral devices for human interface. The computer blade, such as computer blade 105A, may communicate with the peripheral devices coupled to the computer blade 105A by sending and receiving encoded human interface signals transmitted over the connecting cable 151A. In one embodiment, a cage 113, e.g., a metal cabinet or chassis, may have a plurality of slots, such as slots 111A, 111B, and 111C. The computer blades 105 may be inserted into the slots 111. The cage 113 may also include cage connectors (not shown) to couple the computer blades 105 to the connecting cables 151.

The computer blades 105 may be installed in the cage 113 at a central location, while the peripheral devices for each computer blade 105 may be located remotely from the cage 113, such as at respective work areas of the users of the computer blades 105. The separation of the peripheral device groups from the computer blades 105 may allow easier software installation across a network, such as, but not limited to, for example, installing software from CD-ROMs, and may provide a central location of multiple computers which may simplify both hardware and software maintenance.

Each computer blade 105 may also be coupled to a network 115 through an on-board network logic (not shown). The network 115 may be a Local Area Network (LAN) or a Wide Area Network (WAN), such as the Internet, although other networks are also contemplated. As mentioned above, in one embodiment, the computer blades 105 may be inserted into slots 111 of the cage 113, and coupled to respective peripheral device groups through the cage connectors (not shown) and connecting cables 151. In one embodiment, each computer blade 105 may also be coupled to the network 115 through the cage connectors (not shown) and a network cable, such as Ethernet cables 163A, 163B, and 163C.

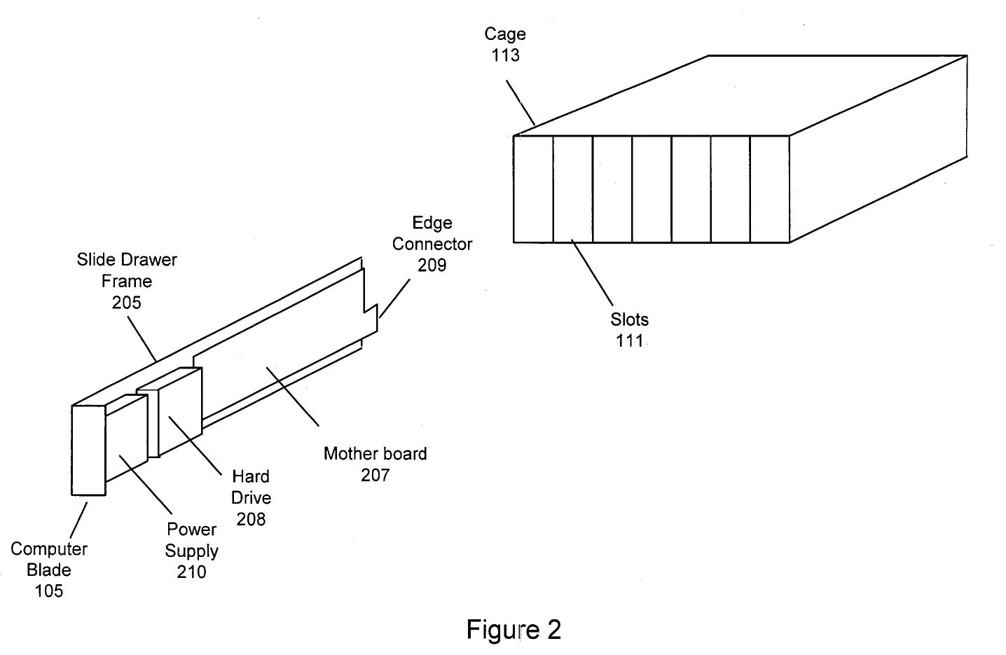

FIG. 2—Computer Blade

Referring to FIG. 2, an embodiment of the computer blade 105 is shown. In one embodiment, the computer blade 105 may include components such as, but not limited to, a slide drawer frame 205, motherboard 207, a power supply 210, and a hard drive 208, as shown, where the motherboard 207, the power supply 210, and the hard drive 208 are preferably coupled to, e.g., mounted on, the slide drawer frame 205. In one embodiment, the slide drawer frame 205 may be three rack units high (or approximately 5.25 inches) to occupy a much smaller space than standard PC units, although other slide drawer frame 205 dimensions may also be within the scope of the invention.

The motherboard 207 may be a printed circuit board with components such as, but not limited to, a central processing unit (CPU), memory, and LAN interface. Other types of motherboards and other types of motherboard components are also contemplated. The hard drive 208 may be a non-volatile memory such as, but not limited to, a hard drive, optical drive, and/or flash memory. The computer blade 105 may communicate with external systems e.g., peripheral devices and networks, through an edge connector 209. In one embodiment, the edge connector 209 may transmit signals e.g., network signals, input/output (I/O) signals, video signals, audio signals, and USB signals, among others. For example, the edge connector may communicate network signals to a network and encoded human interface signals to a group of peripheral devices.

As mentioned above, in a preferred embodiment, the computer blade 105 may include power supply 210 mounted on the slide drawer frame 205, for example, with an internal power source or, alternatively, coupled to an external power source (not shown) to provide power to the computer blade 105. The power supply 210 may convert local main power to an appropriate voltage for the computer blade 105. Because computer blade 105 has an individual or dedicated power supply 210, if the power supply 210 fails, computer blade 105 may be the only computer blade that fails. In another embodiment, a single power supply located in the cage 113 (shown in FIG. 1) may supply power to several computer blades, such as computer blades 105 (shown in FIG. 1). However, a single power supply for the cage 113 (shown in FIG. 1) may be a single point of failure for the cage 113. If the single power supply fails, multiple computer blades may also fail.

As FIG. 2 also illustrates, in one embodiment, cage 113 may have a plurality of slots 111, to house respective computer blades, such as computer blade 105. The computer blade 105 may be inserted into one of the slots 111 of the cage 113. The cage 113 may include a cage connector (not shown) to couple to the edge connector 209 on the computer blade 105. The cage connector may also include an external second connector (not shown) that is electrically coupled to the computer blade 105 when the computer blade 105 is inserted into the slot 111. The external second connector may be further coupled to the connecting cables 151 (shown in FIG. 1) for communication of the encoded human interface signals to a group of peripheral devices, e.g., a human interface, at a remote location. The use of the cage connectors (not shown) as an intermediate connection between computer blade 105 and the connecting cable 151 (shown in FIG. 1) may allow the removal and exchange of computer blade 105 without the need to disconnect the connecting cable 151 (shown in FIG. 1) from the cage 113. If the computer blade 105 fails, the computer blade 105 may be removed and a new computer blade (not shown) inserted in a slot 111.

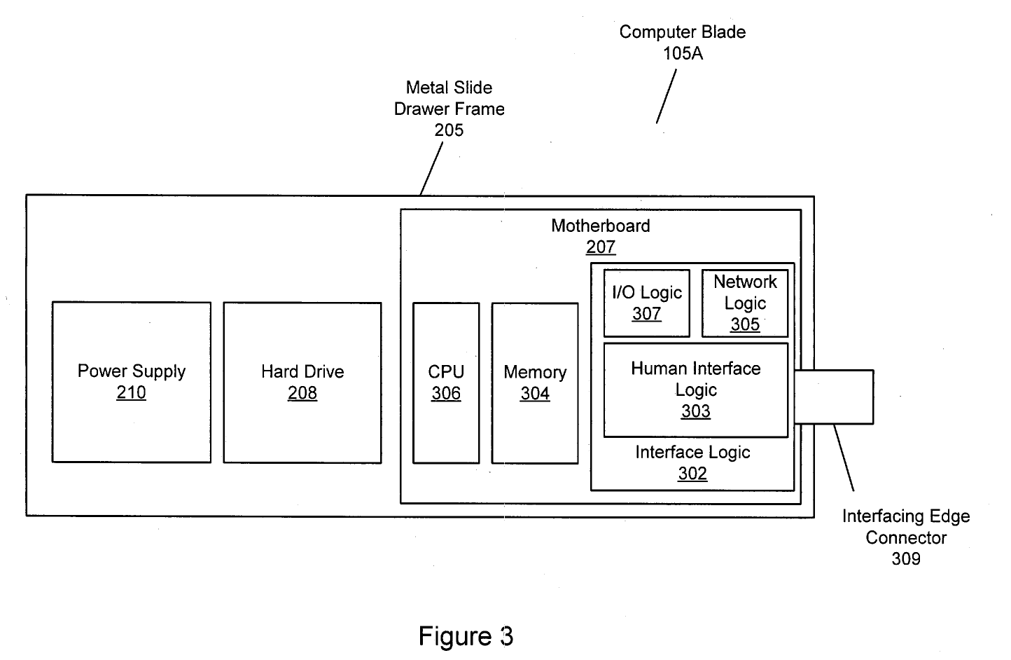

FIG. 3—Computer Blade Components

Referring to FIG. 3, an embodiment of computer blade 105 with power supply 210, hard drive 208, and motherboard 207 is shown. Thus, the computer blade 105 may include elements that make up a standard PC, such as, but not limited to, motherboard 207 with various components, e.g., a processor, e.g., a CPU 306, memory 304, and interface logic 302, which may include network logic 305, I/O logic 307, and interface logic 303, as well as other interface circuitry associated with the motherboard 207, configured on a single card. The network logic 305 may include a LAN or WAN connection, such as, but not limited to, an IEEE803.2 (10/100 BaseT) Ethernet connection, and circuitry for connecting to peripheral devices coupled to the computer blade 105. The computer blade 105 may be electrically coupled to the cage 113 (shown in FIG. 2) through the edge connector 209 that in a preferred embodiment may face to the rear of the computer blade 105. In one embodiment of the invention, the computer blade 105 may slide into slot 111 of the cage 113 (shown in FIG. 2), thereby making contact with the cage connector (not shown).

Thus, in one embodiment, the computer blade 105 may include network interface logic 305 included on a printed circuit board for interfacing to a network. The network logic 305 may encode network signals into a format suitable for transmission to the network. The network logic 305 may also receive encoded network signals from the network, and decode the encoded network signals for use by the computer blade 105. In one embodiment, the motherboard 207 may further include logic supporting PCI slot-based feature cards.

In one embodiment, the components on the computer blade 105 may be arranged from front to back for thermal efficiency. For example, the interface logic 302 may be located at the rear of the computer blade 105, while the power supply 210 and hard disk 208 may be located at the front of the computer blade 105. In various embodiments, the computer blade 105 may have different slide drawer frame shapes, such as, but not limited to, square, rectangle, cubic, hexagonal, and three-dimensional rectangular forms. In one embodiment, the computer blade 105 may have components mounted on either side or both sides of the computer blade 105. If the slide drawer frame 205 has a three-dimensional shape, the components may be mounted on an inside surface and outside surface of the slide drawer frame 205.

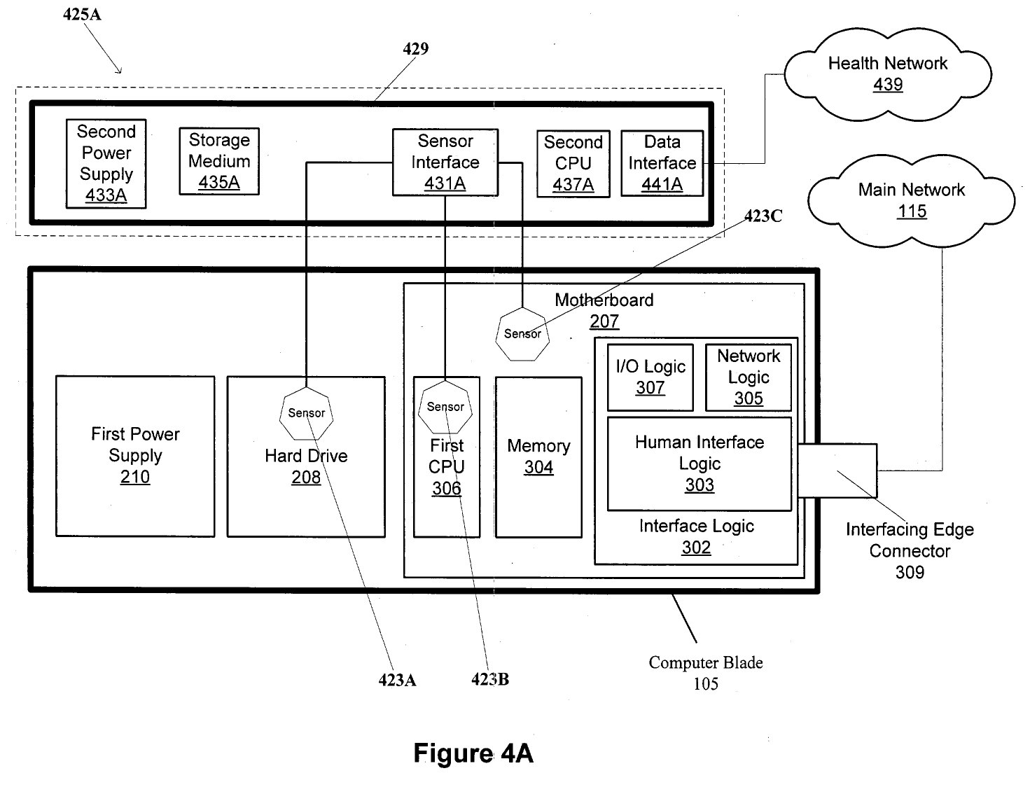

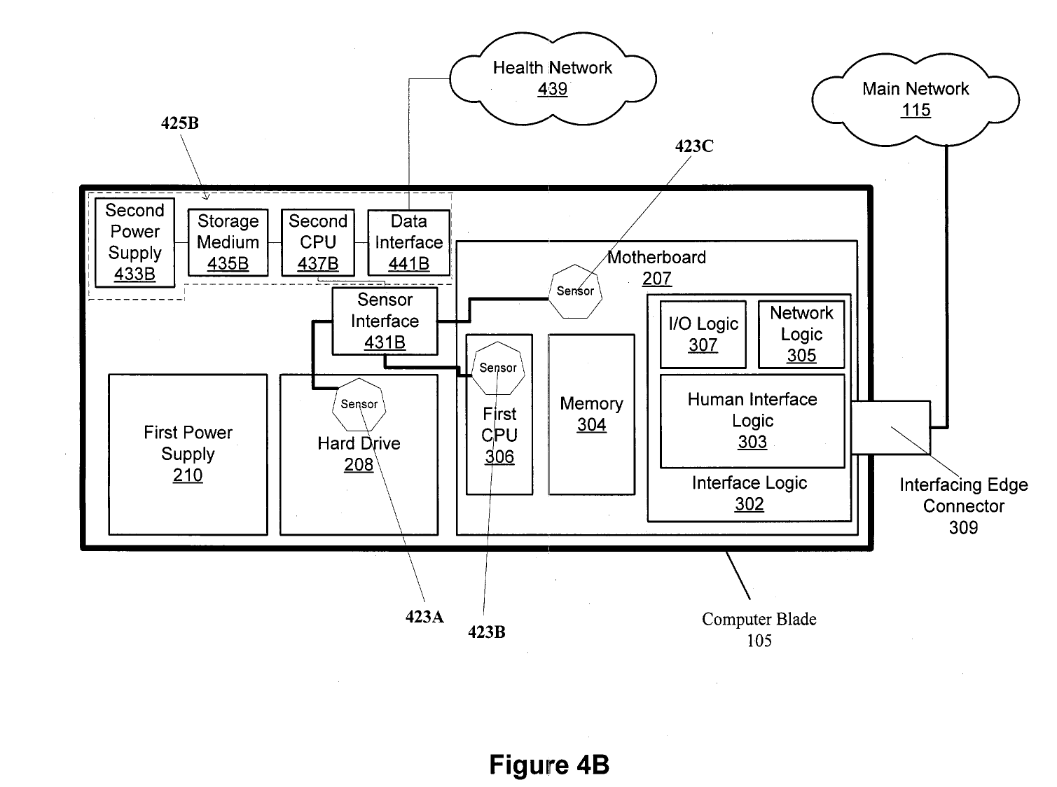

FIGS. 4A and 4B: A Computer Blade And A Health Computer

FIG. 4A illustrates an embodiment of a first computer (e.g., the computer blade 105) attached to a second computer (e.g., the health computer 425 on a separate blade 429). FIG. 4B illustrates an embodiment of a computer blade 105 with an incorporated health computer 425B. In one embodiment, the computer blade 105 may have standard computer components, including, but not limited to, power supply 210, referred to as first power supply 210, hard drive 208, interfacing edge connector 209, and motherboard 207, as described above with reference to FIG. 3. The motherboard 207 may have components including, but not limited to, a first processor (e.g., a central processing unit (CPU) 306), a first memory medium (e.g., a memory 304), an interface logic 302 with an Input/Output (I/O) logic 307, a network logic 305, and a human interface logic 303. Other components on the motherboard are also contemplated. The computer blade 105 may be coupled to a main network 115. In addition, other computers and computer types may also be within the scope of the invention.

In one embodiment, the health computer 425 may comprise a sensor interface 431A, a second CPU 437A, a second storage medium 435A, a second power supply 433A, and a data interface 441 on the blade 429. In one embodiment, the sensor interface 431 may be a part of the health computer 425. In another embodiment, the sensor interface 431 may be separate from the health computer 425. In one embodiment, the storage medium may store information about the first computer, such as, for example, a serial number and configuration data for access by the health network and/or other computers. In one embodiment, the blade 429 may be a computer blade dedicated only to health computer functionality. In another embodiment, the blade 429 may be a neighboring computer blade that also functions as a standard computer blade. In one embodiment, the components of the health computer 425 may be coupled to the computer blade 105. For example, as seen in FIG. 4B, the second power supply 433B, the storage medium 435B, the second CPU 437B, the sensor interface 431B, and the data interface 441B may be coupled directly to the computer blade 105.

In another embodiment, the health computer 425 may be comprised in a functional module. For more information on functional modules, please see U.S. patent application Ser. No. 09/728,669 titled “A System Of Co-Located Computers In A Framework Including Removable Function Modules For Adding Modular Functionality” filed on Dec. 1, 2000, whose inventor is Barry W. Thornton and which is incorporated by reference herein. In yet another embodiment, the components of the health computer may be at a remote location, i.e., remote from computer blade 105. Other locations for the components of the health computer 425 are also contemplated.

In one embodiment, sensors, e.g., sensors 423A, 423B, and 423C, may be coupled to various components on the computer blade 105. In the embodiment shown, three sensors are used, however, any number of sensors may be used to monitor any of the components of the computer blade 105. In one embodiment, the health computer 425 may be coupled to sensors 423 on multiple computer blades (i.e., the health computer 425 may monitor the attributes of multiple computers at the same time).

In one embodiment, sensors 423 may measure attributes on the computer blade 105 and send signals indicative of these attributes to a sensor interface 431 on the health computer 425. In one embodiment, the CPU 437 on the health computer 425 may monitor measured attributes of the computer blade 105 and send information about the attributes on the computer blade 105 through a data interface 441 to a health network 439. In one embodiment, the health network 439 may be independent from the main network 115, and thus, may continue to operate if the main network 115 fails.

In one embodiment, the health computer 425 may use the second power supply 433 to allow the health computer 425 to operate even if the first power supply 210 and/or computer blade 105 has failed. In another embodiment, the health computer 425 may be powered by the first power supply 210 instead of the second power supply 433. The health computer 425 may also have a storage medium 435 to store program instructions executable by the CPU 437 to monitor attributes detected by the sensors 423.

The sensors 423 may vary in type relative to each other and in attributes measured. For example, the sensors 423 may include thermocouples that measure temperature (e.g., a temperature of the component and a temperature of airflow near the component). As another example, one or more of the sensors 423 may measure airflow velocity and/or airflow volume near a component. For example, the sensors may measure a pressure differential or a temperature drop of actual airflow to detect the airflow velocity and/or airflow volume. As other examples, the sensors may measure steady state voltages of the component, voltage fluctuations of the component, and/or current consumption of the component. If the component is a storage medium, such as hard drive 208, the sensor 423 may measure attributes on the hard drive 208 such as, but not limited to, write error rate, motor noise, motor power, and spin-up rates of the hard drive 208. The sensors 423 may also measure accelerations of the components and vibrations of the components. For example, a sensor may measure a sudden acceleration indicating that the computer 401 has been dropped or bumped. Other attributes may also be measured by the sensors 423 where each sensor 423 measures a respective attribute. In other words, sensors 423 may comprise a sensor suite where each sensor in the sensor suite may measure a different attribute. In addition, in some embodiments, each sensor 423 may measure one or more attributes.

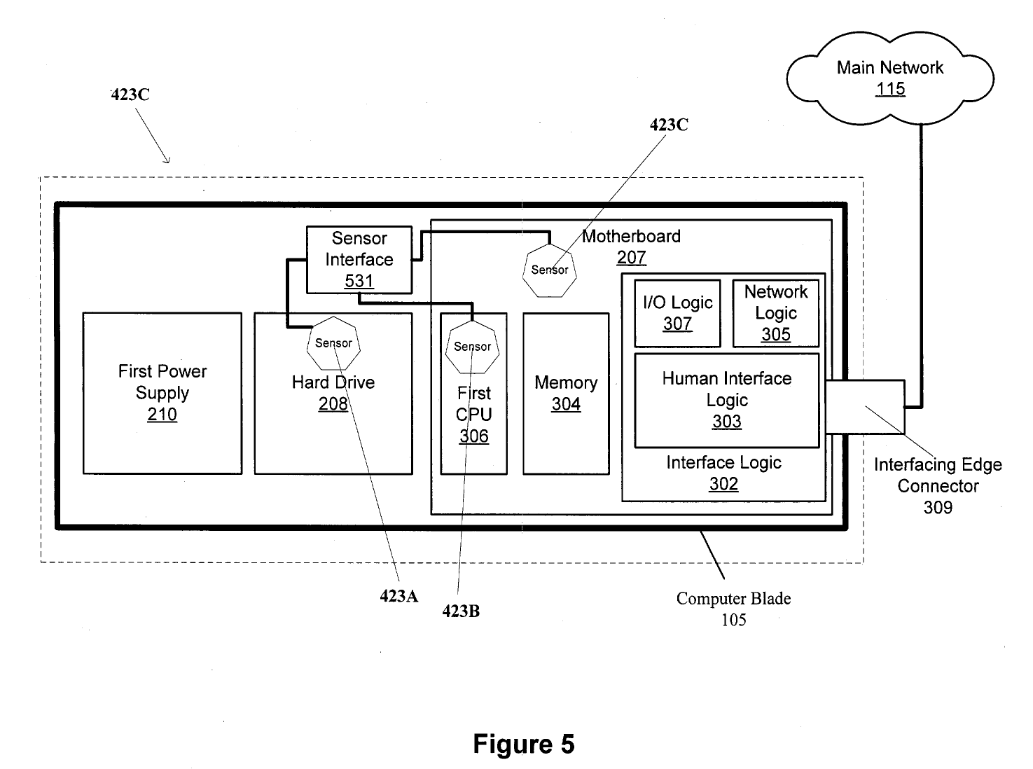

FIG. 5: A Blade Operating as an On-Board Health Computer 425

FIG. 5 illustrates an embodiment of a computer blade 105 with an internal sensor interface 531. In other words, in the embodiment of FIG. 5, the health computer 425C uses components of the computer blade 105, i.e., is implemented by or on the computer blade. In one embodiment, the internal sensor interface 531 may be operable to receive signals from sensors 423 and to send those signals to the first CPU 306 on the computer blade 105. The signals may be interpreted by circuitry on the sensors 423, by circuitry on the internal sensor interface 531, and/or by the CPU 306. In one embodiment, the signals may not be interpreted at all. Other embodiments for signal interpretation are also contemplated.

As noted above, in one embodiment, there may be another, separate, health network coupled to the computer blade 105, and the computer blade 105 may communicate conditions over the health network to a second computer. As described above, in one embodiment, the separate health network may operate even if the main network 115 fails.

If the internal sensor interface 531 and the first CPU 306 are powered by first power supply 210, information about the computer blade 105 may not be collectable if the computer blade 105 fails (i.e., especially if the first power supply fails). Thus, in one embodiment, a back-up power supply may provide power to the internal sensor interface 531 and the first CPU 306 to detect conditions even if the first power supply 210 fails.

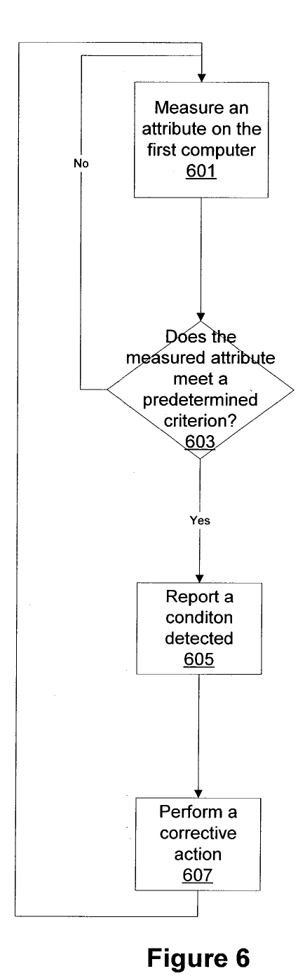

FIG. 6: A Flowchart for Detecting Conditions on a Computer by Comparing Measured Attributes to a Predetermined Criterion

FIG. 6 is a flowchart of an embodiment of a method for detecting a condition on a computer. It should be noted that in various embodiments one or more of the following steps may be performed concurrently, in a different order than shown, or may be omitted entirely. Other additional steps may also be performed as desired.

In 601, an attribute may be measured on a first computer, such as, for example, computer blade 105, using a sensor. In one embodiment, the health computer may monitor attributes collected from multiple computers. As described above, sensors may measure attributes such as, but not limited to, temperature, airflow, voltage, current, and accelerations. The sensor interface on the health computer may interpret the signals and/or send the signals over a health network. As also described above, in various embodiments, the interpreting circuitry may be in the sensor or in the health computer. For example, if the sensor is a thermocouple for detecting temperature, the sensor interface may contain circuitry to convert a thermocouple signal from the sensor into a temperature measurement to analyze using the health computer or to send over the health network. Other locations for the interpreting circuitry may also be within the scope of the invention. In one embodiment, the signals from the sensors may not be interpreted. In other words, the signals may be used in their raw form.

In one embodiment, the health computer may monitor several measured attributes. The sensors may send signals to the sensor interface on the first computer or the sensor interface on a health computer powered by a separate power supply. For example, the sensor interface may send the signals to a CPU such as, but not limited to, the first computer's CPU, a CPU located on a health computer, and/or a CPU accessible over a network. In one embodiment, the health computer may send attribute values through the health network 439 in response to a request for attribute data by a second computer on the health network. Other reasons for reporting the attributes without detecting a potential failure are also contemplated. For example, attributes may be reported in accordance with a specified schedule, as part of a statistical sampling process, and so forth.

In 603, the health computer may determine if the attribute measured on the first computer meets a predetermined criterion. For example, if the. sensor measures an attribute of a power supply, e.g., a temperature of the power supply, the predetermined criterion may include the temperature exceeding a safe temperature for the power supply. If the temperature measured by the sensor is greater than the safe temperature for the power supply, the measured attribute may meet the predetermined criterion for detecting a condition. As another example, if the sensor measures an airflow velocity near a CPU, a predetermined criterion may include the airflow velocity falling below a safe level. If the airflow velocity falls below the safe level (specified as predetermined criteria), which may lead to overheating, the attribute may meet the predetermined criterion for detecting a condition. As yet another example, a performance metric may be calculated from a history of accumulated attributes and compared to predetermined criteria (e.g., a standard deviation or mean). In another embodiment, the history of accumulated attributes may be analyzed according to a pattern defined by predetermined criteria (e.g., a history of decreasing air flow or increasing temperature). Other methods of analyzing the history of accumulated attributes are also contemplated. Alternatively, a plurality of concurrent measured attributes may be analyzed, where a particular combination of measured values indicates a condition meeting the specified criteria. For example, a slow air speed and a rising CPU temperature may indicate that a CPU failure is imminent.

Predetermined criteria may be specified by a system administrator or product engineer, although other sources of predetermined criteria are also contemplated. The health computer and/or the computer blade 105, may initiate or recommend a diagnostic check to make sure that no damage was sustained by the computer blade 105.

If the predetermined criterion is met, in 605, the condition may be reported. For example, the condition may be reported to any of several entities, including, but not limited to, the first computer, the health computer, and over a network.

In 607, the health computer may take action, such as, for example, alerting an administrator, backing up a hard drive of the computer blade, and taking corrective action, among others. Examples of corrective action include, but are not limited to, turning on an emergency fan near the first computer if the temperature is too high, terminating power to the first computer if a voltage or current of a component on the first computer exceeds a certain level, and performing a diagnostic procedure on the computer blade. Other corrective actions may also be within the scope of the invention. For example, in one embodiment, if a condition is detected, a second computer on the health network may respond by trying to fix the computer blade or attempting to prepare for a failure, e.g., by backing up data from the computer blade (e.g., a fail-over back-up). In one embodiment, the second computer on the health network (or optionally, the health computer) may notify other computers on the main network about the potential failure. The other computers on the main network may then act to correct and/or prepare for the failure. Other actions by the second computer on the health network may also be within the scope of the invention. For example, in one embodiment, if the potential failure relates to the computer blade's hard drive, once the data from the computer blade has been backed up onto a different storage medium, the second computer (or the health computer, or the computer blade) may configure the computer blade to access the backup storage medium instead of the original hard drive. It is noted that the detection system may continue monitoring attributes to detect conditions even after the condition has been reported. If the condition continues to meet the predetermined criterion, the condition may continue to be reported until the condition is corrected. In one embodiment, if the condition remains uncorrected for a specified amount of time, the report may be escalated, e.g., an alarm may be transmitted, or the report may be sent to a different location, e.g., to an administrative supervisor. In one embodiment, the computer blade itself may try to correct the condition or attempt to prepare for the failure without sending information to the second computer on the main network.

If the predetermined criterion is not met, then in 601, the detection system may continue monitoring measured attributes of the first computer, as indicated.

Referring to FIG. 6, various embodiments may further include receiving, sending, or storing instructions and/or data implemented in accordance with the foregoing description upon a carrier medium. Generally speaking, a carrier medium may include storage media or memory media such as magnetic or optical media, e.g., disk or CD-ROM, volatile or non-volatile media such as RAM (e.g. SDRAM, DDR SDRAM, RDRAM, SRAM, etc.), ROM, etc. as well as transmission media or signals such as electrical, electromagnetic, or digital signals, conveyed via a communication medium such as network and/or wireless link.

Further modifications and alternative embodiments of various aspects of the invention will be apparent to those skilled in the art in view of this description. Accordingly, this description is to be construed as illustrative only and is for the purpose of teaching those skilled in the art the general manner of carrying out the invention. It is to be understood that the forms of the invention shown and described herein are to be taken as the presently preferred embodiments. Elements and materials may be substituted for those illustrated and described herein, parts and processes may be reversed, and certain features of the invention may be utilized independently, all as would be apparent to one skilled in the art after having the benefit of this description of the invention. Changes may be made in the elements described herein without departing from the spirit and scope of the invention as described in the following claims.

What is claimed is:

1. An apparatus, comprising:
a first computer, comprising:
a first processor; and
a first memory medium coupled to the first processor;
a second computer, comprising:
a second processor; and
a second memory medium coupled to the second processor;
one or more sensors coupled to the second computer, wherein the one or more sensors are operable to measure at least one attribute of the first computer;
wherein the second memory medium stores program instructions executable by the second processor to:
monitor the measured at least one attribute;
detect a condition of the first computer based on the monitored at least one attribute, wherein the condition is specified by one or more predetermined criteria; and
perform one or more actions in response to the detected condition.

2. The apparatus of claim 1, wherein the first computer further comprises a first power supply and the second computer further comprises a second power supply, wherein the second power supply is operable to provide power independently of the first power supply.

3. The apparatus of claim 1, wherein the one or more sensors coupled to the second computer are operable to measure at least one attribute of a third computer.

4. The apparatus of claim 1, wherein the second computer is comprised in a functional module.

5. The apparatus of claim 1, wherein at least one of the one or more sensors measures a temperature of a component of the first computer.

6. The apparatus of claim 1, wherein at least one of the one or more sensors measures a temperature of an airflow near a component of the first computer.

7. The apparatus of claim 1, wherein at least one of the one or more sensors measures an airflow velocity near a component of the first computer.

8. The apparatus of claim 1, wherein at least one of the one or more sensors measures an airflow volume near a component of the first computer.

9. The apparatus of claim 1, wherein at least one of the one or more sensors measures a steady state voltage of a component of the first computer.

10. The apparatus of claim 1, wherein at least one of the one or more sensors measures a voltage fluctuation of a component of the first computer.

11. The apparatus of claim 1, wherein at least one of the one or more sensors measures a current consumption of a component of the first computer.

12. The apparatus of claim 1, wherein at least one of the one or more sensors measures a write error rate of a hard drive on the first computer.

13. The apparatus of claim 1, wherein at least one of the one or more sensors measures a motor noise of a hard drive on the first computer.

14. The apparatus of claim 1, wherein at least one of the one or more sensors measures a motor power of a hard drive on the first computer.

15. The apparatus of claim 1, wherein at least one of the one or more sensors measures a spin up rate of a hard drive on the first computer.

16. The apparatus of claim 1, wherein the at least one of the one or more sensors measures an acceleration of a component of the first computer.

17. The apparatus of claim 1, wherein the at least one of the one or more sensors measures a vibration of a component of the first computer.

18. The apparatus of claim 1, wherein the second computer is communicatively coupled to a first network, wherein the first computer is not communicatively coupled to the first network.

19. The apparatus of claim 1, wherein the one or more actions includes a fail-over back-up of the first computer.

20. The apparatus of claim 1, wherein the one or more actions includes communicating the condition over the first network.

21. The apparatus of claim 1, wherein the second computer is a computer blade.

22. The apparatus of claim 1, wherein the attribute is a temperature of a component of the first computer and the predetermined criterion is met if the temperature of the component of the first computer exceeds a safe temperature.

23. The apparatus of claim 1, wherein the one or more actions includes communicating the condition over the first network if a computer on the first network sends a request to the second computer to communicate the condition over the first network.

24. The apparatus of claim 1, wherein the one or more actions includes communicating the condition to the first computer.

25. The apparatus of claim 1, wherein the second memory medium further stores a serial number and/or configuration of the first computer.

26. The apparatus of claim 1, wherein the first computer is a computer blade.

27. The apparatus of claim 1, wherein, in detecting the condition, the program instructions are further executable by the second processor to:
accumulate a history of the measured attributes;
calculate a performance metric based on the accumulated history of measured attributes; and
determine if the performance metric is specified by the one or more predetermined criteria.

28. The apparatus of claim 1, wherein, in detecting the condition, the program instructions are further executable by the second processor to:
accumulate a history of the measured attributes; and
analyze the history of the measured attributes according to a pattern in the predetermined criteria for a match.

29. The apparatus of claim 1, wherein, in detecting the condition, the program instructions are further executable by the second processor to:
accumulate a history of two or more concurrently measured attributes; and
analyze the history of the two or more concurrently measured attributes according to a pattern in the predetermined criteria for a match.

30. A method, comprising:
measuring at least one attribute of the first computer;
monitoring the measured at least one attribute;
detecting a condition of the first computer based on the monitored at least one attribute, wherein the condition is specified by one or more predetermined criteria; and
performing one or more actions in response to the detected condition.

31. A carrier medium comprising program instructions, wherein the program instructions are computer-executable to:
measure at least one attribute of a first computer;
monitoring the measured at least one attribute of the first computer;
determining whether the attribute meets a predetermined criterion;
detecting a condition of the first computer based on the monitored at least one attribute, wherein the condition is specified by one or more predetermined criteria;
communicating the detected condition to a second computer; and
performing one or more actions in response to the detected condition.

32. A system, comprising:
means for measuring at least one attribute of a first computer;
means for monitoring the measured at least one attribute;
means for detecting a condition of the first computer based on the monitored at least one attribute, wherein the condition is specified by one or more predetermined criteria; and
means for performing one or more actions in response to the detected condition.
